(19) United States
(12) Patent Application Publication
(10) Pub. No.: US 2008/0232538 A1
(43) Pub. Date: Sep. 25, 2008

(54) TEST APPARATUS AND ELECTRONIC DEVICE

(75) Inventor: MASARU GOISHI, TOKYO (JP)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: ADVANTEST CORPORATION, TOKYO (JP)

(21) Appl. No.: 11/688,834

(22) Filed: Mar. 20, 2007

(51) Int. Cl. G01F 15/06

(52) U.S. Cl. 377/19

(57) ABSTRACT

Provided is a test apparatus for testing a device under test, the test apparatus including: a pattern generator that generates an expected value pattern of an output signal of the device under test; a timing generator that generates a timing signal indicating a timing for acquiring the output signal of the device under test by delaying a reference clock; a comparator that acquires the output signal of the device under test at the timing designated by the timing signal and compares the acquired output signal to the expected value pattern; and a measurement circuit that starts operating at the timing designated by the timing signal and counts a number of pulses of the output signal of the device under test.

### BACKGROUND

1. Technical Field

The present invention relates to a test apparatus and an electronic device. In particular, the present invention relates to a test apparatus and an electronic device for measuring a frequency and a period of an output signal of a device under test.

2. Related Art

A test apparatus for testing a device under test (DUT) inputs a test signal to a terminal of the DUT, and obtains an output signal in response to the test signal, from the terminal of the DUT. Then the test apparatus tests the function of the DUT by comparing the output signal to an expected value expected in case of inputting the test signal to the DUT. Further, after measuring the number of pulses of an output signal from the DUT for a predetermined time duration, the test apparatus obtains a frequency or a period by computation using the number of pulses measured for the predetermined time duration. In the current state, we have not yet recognized the existence of any prior art, and so the description thereof is omitted.

When general test apparatuses measure a frequency or a period of an output signal (hereinafter simply referred to as “frequency measurement”), a signal designating a timing at which the number of pulses starts to be counted (i.e. a timing for starting measurement) is outputted from a control apparatus that controls the test. In other words, the frequency measurement starts asynchronously with respect to a test signal or an output signal.

Consequently, there are cases where it is necessary to allocate a setup time for making sure that an output signal is outputted prior to starting of frequency measurement. This leads to a possibility of hindering shortening of a test time. Moreover, since the relation between the timing for starting the measurement and the phase of the output signal pulse is asynchronous, there is a possibility that the period required to output a certain number of pulses fluctuates in the range of a pulse interval. As a result, this leads to a possibility of hindering realization of higher accuracy for a result of frequency measurement.

Furthermore, in some cases, it is desired to count the number of pulses when the output signal is in a certain state. In such cases, typically measurement starts upon detection of transition into the certain state. However, even if an output signal is detected to have changed to the certain state, a function of starting to count the number of pulses in synchronization with the timing of state transition of the output signal has not been provided so far. As a result, such measurement has been difficult.

### SUMMARY

In view of this, as one aspect, the present invention aims to provide a test apparatus and an electronic device that are able to solve the above-described problems. This purpose is achieved by combinations of features described in the independent claims. The dependent claims define further advantageous and concrete examples of the present invention.

That is, according to a first aspect of the present invention, there is provided a test apparatus for testing a device under test, the test apparatus including: a pattern generator that generates an expected value pattern of an output signal of the device under test; a timing generator that generates a timing signal indicating a timing for acquiring the output signal of the device under test by delaying a reference clock; a comparator that acquires the output signal of the device under test at the timing designated by the timing signal and compares the acquired output signal to the expected value pattern; and a measurement circuit that starts operating at the timing designated by the timing signal, and counts a number of pulses of the output signal of the device under test.

The above-stated summary does not list all the features essential for the present invention, and sub-combination of the mentioned groups of features may also be considered as the inventions.

### BRIEF DESCRIPTION OF THE DRAWINGS

FIG. 1 shows an example of a test apparatus according to the present embodiment together with a DUT.

FIG. 2 shows an example of a measurement circuit according to the present embodiment.

FIG. 3 shows a flow for measuring the number of pulses of an output signal with use of the test apparatus according to the present embodiment.

FIG. 4 shows another example of the measurement circuit according to the present embodiment.

FIG. 5 shows a further different example of the measurement circuit according to the present embodiment.

### DESCRIPTION OF EXEMPLARY EMBODIMENTS

As follows, an aspect of the invention is described by way of embodiments. The following embodiments do not limit the invention relating to the scope of the claims. Additionally, not all the features or the combinations thereof described in the embodiments are necessarily essential to the invention.

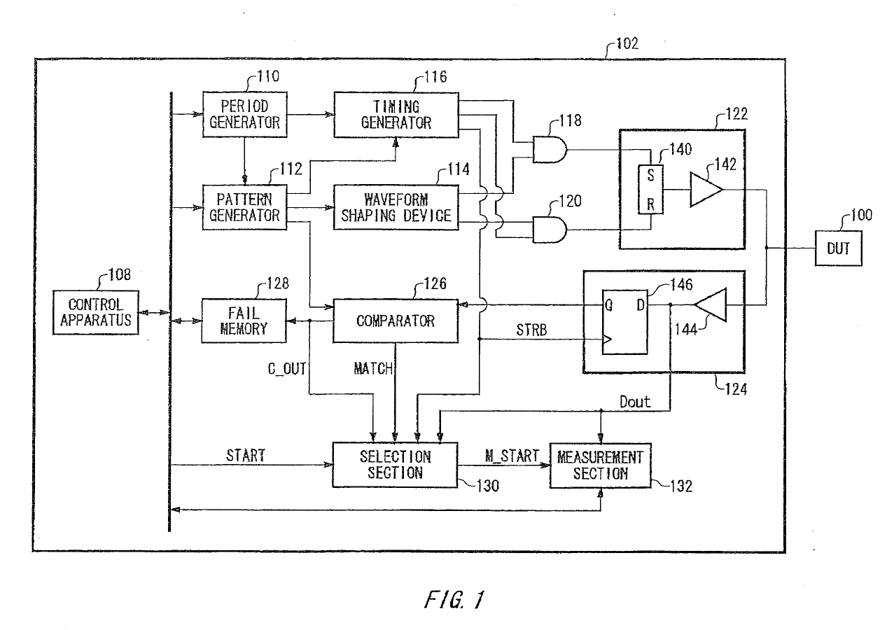

FIG. 1 shows a configuration of a test apparatus 102 according to the present embodiment together with a DUT 100. The DUT 100 is a device under test that is to be tested by the test apparatus 102. Examples of the DUT 100 include a memory LSI such as a DRAM (dynamic random access memory) and a flash memory, a logic IC, and a logic LSI.

The test apparatus 102 tests one or a plurality of DUT(s) 100. The test apparatus 102 includes a control apparatus 108, a period generator 110, a pattern generator 112, a waveform shaping device 114, a timing generator 116, an AND gate 118, an AND gate 120, a driver section 122, a timing comparing section 124, a comparator 126, a fail memory 128, a selection section 130, and a measurement circuit 132.

The control apparatus 108 is for example a computer system, and controls tests directed to the DUT 100 based on a program. In particular, when controlling measurement in the measurement circuit 132 directed to the number of pulses of an output signal of the DUT, the control apparatus 108 generates a selection signal for selecting which signal is to be used as a measurement start signal M_START. Then the control apparatus 108 inputs the selection signal to the selection section 130.

In addition, the control apparatus 108 generates a start signal START as one of the signals that become the measurement start signal M_START by being selected by the selection section 130. Furthermore, the control apparatus 108 obtains a result of measurement in the measurement circuit 132. Then the control apparatus 108 calculates either the frequency or the period of the output signal of the DUT 100, with use of the result.

The period generator 110 generates a reference clock for operating each section within the test apparatus 102 during testing of the DUT 100. In addition, the period generator 110 defines a period of each test cycle (test period) included in a test. The test period may be defined so that each test period has the same time length with one another, or that each test period has a different time length from one another.

The pattern generator 112 generates a test pattern being a pattern of a test signal supplied to a terminal of the DUT 100, and an expected value pattern being a pattern of an output signal expected to be outputted as a result of the test signal being supplied to the DUT 100. Both of the test pattern and the expected value pattern are generated for each test period determined by the period generator 110. The generated test pattern is supplied to the waveform shaping device 114. The generated expected value pattern is supplied to the comparator 126. Examples of the pattern generator 112 are a sequential pattern generator that generates a corresponding test pattern in accordance with an instruction sequence of a test program, and an algorithmic pattern generator that generates a test pattern based on a predetermined algorithm.

The waveform shaping device 114 shapes a waveform of a test pattern inputted from the pattern generator 112. The waveform shaping device 114 outputs a signal after shaping of the waveform based on the test pattern, to the AND gate 118 and the AND gate 120. For example, the waveform shaping device 114 outputs a set signal of a logical value “H” to the AND gate 118, if a test signal is to be set as a high level. When a test signal is to be set as a low level, the waveform shaping device 114 outputs a reset signal of a logical value “H” to the AND gate 120.

The timing generator 116 outputs a set timing signal which indicates a timing for setting a test signal to be applied to the DUT 100 to a high level, a reset timing signal which indicates a timing for setting the test signal to a low level, and a strobe signal STRB being a timing signal which indicates a timing for acquiring an output signal from the DUT 100. A set timing signal, a reset timing signal, and a strobe signal STRB are generated by delaying the reference clock based on the timing information designated by the pattern generator 112, and/or the timing information pre-set to the timing generator 116.

The timing generator 116 supplies the generated set timing signal to the AND gate 118. In addition, the timing generator 116 supplies the reset timing signal to the AND gate 120. Furthermore, the timing generator 116 supplies the generated strobe signal STRB to the timing comparing section 124. The strobe signal STRB is supplied after being adjusted so that the measurement can start at a timing when the output signal from the DUT 100 reaches the timing comparing section 124.

The AND gate 118 takes a logical AND of a set signal outputted from the waveform shaping device 114 and a set timing signal outputted from the timing generator 116, and outputs a set signal for a timing that is in accordance with the timing signal outputted from the timing generator 116. Likewise, the AND gate 120 takes a logical AND of a reset signal outputted from the waveform shaping device 114 and a reset timing signal outputted from the timing generator 116, and outputs a reset signal for a timing that is in accordance with the timing signal outputted from the timing generator 116.

The driver section 122 is connected to a terminal of the DUT 100, and outputs, to the terminal, a test signal based on a set signal and a reset signal outputted from the AND gate 118 and the AND gate 120. The driver section 122 includes a flip-flop 140 and a driver 142. The flip-flop 140 may be an SR flip-flop that sets an output to a logical value “H” by a set signal, and resets an output to a logical value “L” by a reset signal. The driver 142 converts a test signal outputted from the flip-flop 140 to a designated voltage amplitude level, and outputs the result to the terminal of the DUT 100.

The timing comparing section 124 acquires an output signal outputted from the terminal of the DUT 100, at a timing designated by a strobe signal STRB. Then the timing comparing section 124 supplies the acquired result to the comparator 126. The timing comparing section 124 includes a comparator 144 and a timing comparator 146. The comparator 144 compares the voltage of an output signal from the DUT 100 to a level voltage ViH indicating the logical value “H” and a level voltage ViL indicating the logical value “L”, and outputs a logical value Dout of the output signal based on the comparison result. At the timing that is in accordance with a strobe signal STRB inputted from the timing generator 116, the timing comparator 146 takes in the logical value Dout of the output signal outputted from the comparator 144, and outputs the logical value Dout of the output signal to the comparator 126.

The comparator 126 compares the logical value Dout of the output signal of the DUT 100 acquired at a timing designated by the timing comparing section 124 by means of the strobe signal STRB, and an expected value pattern of the output signal inputted from the pattern generator 112. The comparator 126 includes a logical comparator that outputs, as the comparison result, a comparison result C_OUT indicating matching/non-matching with the expected value, to the fail memory 128. In addition, the comparator 126 includes a matching detector that generates a match signal MATCH when the comparison result satisfies a predetermined condition. For example, the matching detector generates the match signal MATCH when all of one or more arbitrary test terminals (terminal of the DUT 100) match the expected value pattern in an arbitrary test period. Alternatively, the matching detector generates the match signal MATCH when an arbitrary test terminal (terminal of the DUT 100) matches the expected value pattern in one or more arbitrary test periods, for example. The fail memory 128 stores the comparison result C_OUT of the comparator 126.

The selection section 130 selects a measurement start signal M START designating a timing for starting measurement in the measurement circuit 132, in accordance with a selection signal from the control apparatus 108. The measurement start signal M_START is selected by the selection section 130, from among a strobe signal STRB generated by the timing generator 116, a start signal START from the control apparatus 108, a logical value Dout of an output signal of the DUT 100, a comparison result C_OUT of the comparator 126, and a match signal MATCH generated by the matching detector in the comparator 126. The selection section 130 supplies the selected measurement start signal M_START to the measurement circuit 132.

The measurement circuit 132 starts an operation for counting the number of pulses of an output signal of the DUT 100, at a timing designated by the measurement start signal M_START from the selection section 130. During the counting operation, the measurement circuit 132 measures a time duration for which the counting operation continues. Alternatively during the counting operation, the measurement circuit 132 counts the number of pulses for a predetermined time duration. It should be noted here that measurement of a time duration or counting of the number of pulses for a predetermined time duration, performed in the measurement circuit 132, are not essential configurations. In other words, the measurement circuit 132 may be only equipped with a function of counting the number of pulses of an output signal of the DUT 100.

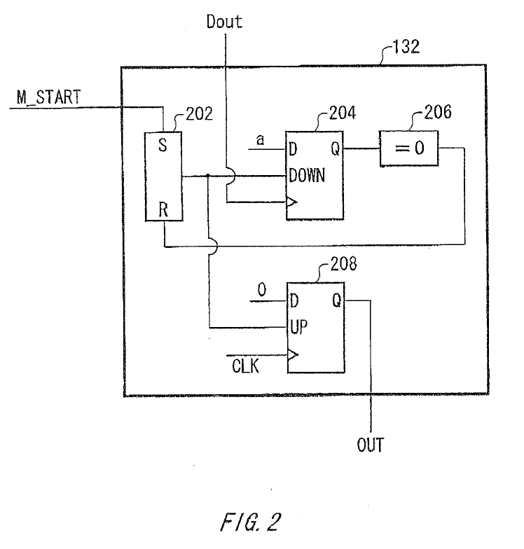

FIG. 2 shows one example of the measurement circuit 132. The measurement circuit 132 according to the present embodiment includes an SR flip-flop 202, a down counter 204, a logical circuit 206, and an up counter 208. The operations of the SR flip-flop 202, the down counter 204, and the up counter 208 are already known, and so the explanation thereof is omitted here. The logical circuit 206 outputs the logical value “H” when 0 is given to its input (i.e. when all the digit outputs from the down counter 204 have become the logical value “L”)

The output from the SR flip-flop 202 is connected to the DOWN input and the UP input of the down counter 204 and the up counter 208. The output Q of the down counter 204 is connected to an input of the logical circuit 206, whereas the output of the logical circuit 206 is connected to the reset input R of the SR flip-flop 202. To the set input S of the SR flip-flop 202, a measurement start signal M_START from the selection section 130 is inputted, whereas to the trigger input of the down counter 204, a logical value Dout of the output signal is inputted. In addition, to the trigger input of the up counter 208, a reference clock CLK is inputted. After performance of a predetermined operation, a value OUT is obtained from the output Q of the up counter 208, as a measurement result in the measurement circuit 132.

Prior to measurement start in the measurement circuit 132, a fixed value “a” is inputted to the input D of the down counter 204, where the fixed value “a” may be set by a user and so on in advance. Furthermore, 0 is inputted to the input D of the up counter 208.

In the aforementioned state, when the set input S of the SR flip-flop 202 detects an up edge of a measurement start signal M_START, the output from the SR flip-flop 202 changes to the logical value “H”. Being triggered by this, the DOWN input and the UP input of the down counter 204 and the up counter 208 are enabled, thereby starting operation of each counter. To be more specific, the down counter 204 performs the down counting from the inputted fixed value “a” each time a pulse of a logical value Dout of an output signal is detected, and the up counter 208 starts counting the number of pulses of the reference clock CLK.

The counting operation of the down counter 204 and the up counter 208 is continued till the output Q of the down counter 204 has become 0 and the output of the logical circuit 206 has become the logical value “H” thereby inputting the logical value “H” to the reset input R of the SR flip-flop 202. In other words, a time duration until the number of pulses of the logical value Dout of the output signal has reached the fixed number “a” is measured using the number of pulses of the reference clock CLK. The frequency of the logical value Dout of the output signal is obtained by calculating as follows:

(frequency of reference clock CLK)×a/(measured number of pulses of reference clock CLK)

When the selection section 130 has selected a strobe signal STRB, the timing for measurement start for the measurement circuit 132 is designated by the strobe signal STRB. As already described, a strobe signal STRB designates a timing that the timing comparing section 124 acquires a logical value Dout of an output signal of the DUT 100. Since the test apparatus 102 and the DUT 100 operate synchronously, it becomes possible to output a strobe signal STRB in synchronization with the DUT 100. Accordingly, the measurement circuit 132 is able to start counting the number of pulses of a logical value Dout of an output signal in synchronization with acquisition of the logical value Dout of the output signal. As a result, it becomes unnecessary to allocate a setup time that is until the output of the DUT 100 starts, enabling to shorten a time required for frequency measurement of an output signal.

Furthermore, since the measurement start of the number of pulses in the measurement circuit 132 is synchronized with acquisition of a logical value Dout of an output signal, counting of the number of pulses and time measurement for the corresponding time duration are always performed for the pulse of the output signal at the same phase. As a result, it is possible to improve the accuracy in frequency measurement of an output signal. Furthermore, since the measurement start of the number of pulses is synchronized with a strobe signal STRB, even in cases where it is desired to count the number of pulses in a predetermined state, it becomes possible to locate the beginning of the predetermined state by adequately outputting a strobe signal STRB.

As described so far, it becomes possible to shorten a time required for measuring frequency of an output signal of the DUT 100, by adopting a strobe signal STRB as a measurement start signal M_START of the measurement circuit 132. In addition, the measurement is performed with high accuracy. Furthermore, it becomes possible to locate the beginning of the state in which it is desired to count the number of pulses. Such effects are likewise obtained when the selection section 130 selects a logical value Dout of an output signal of the DUT 100 as the measurement start signal M_START for the measurement circuit 132. In addition, in the present embodiment, it is also possible to select a start signal START from the control apparatus 108, as the measurement start signal M_START for the measurement circuit 132, which provides various frequency measurement conditions.

When the selection section 130 has selected a match signal MATCH from the comparator 126, the timing for measurement start in the measurement circuit 132 is designated by the match signal MATCH. As already described above, the match signal MATCH is a signal generated when a comparison result satisfies a predetermined condition, and is able to synchronize measurement start in the measurement circuit 132 when a predetermined output pattern is observed (i.e. when a match signal MATCH is outputted). For example, when a match signal MATCH is designed to be generated when all of a plurality of test terminals (terminal of the DUT 100) match the expected value pattern in an arbitrary test period, it becomes possible to start measurement upon detection that a DUT bus output of a parallel signal has outputted a particular code. Alternatively, when a match signal MATCH is designed to be generated when an arbitrary test terminal (terminal of the DUT 100) matches the expected value pattern in a plurality of arbitrary test periods, it becomes possible to start measurement upon detection that a DUT bus output of a serial signal has outputted a particular code.

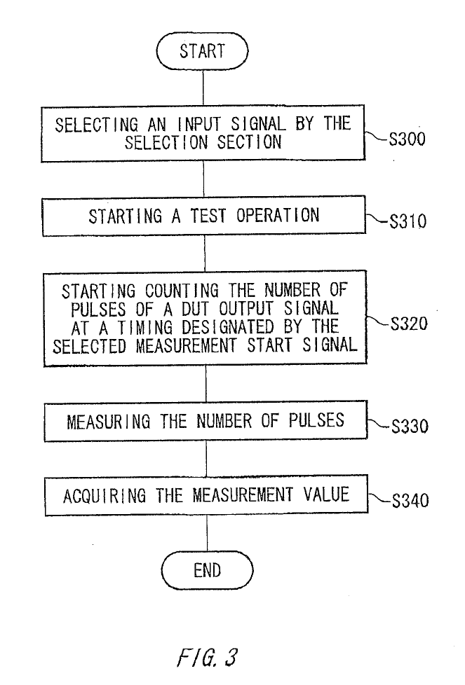

FIG. 3 shows a flow for measuring the number of pulses of a DUT output signal with use of a test apparatus according to the present embodiment. First, the control apparatus 108 generates a selection signal. Then according to the selection signal, the selection section 130 selects an input signal (S300).

When the selection section 130 has selected a strobe signal STRB outputted from the timing generator 116, the strobe signal STRB becomes a measurement start signal M_START. When the logical value Dout of the output signal of the DUT 100 has been selected, the logical value Dout becomes the measurement start signal M_START. When a start signal START from the control apparatus 108 has been selected, the start signal START becomes the measurement start signal M_START. When the comparison result C_OUT in the comparator 126 has been selected, the comparison result C_OUT becomes the measurement start signal M_START. When a match signal MATCH from the comparator 126 has been selected, the match signal MATCH becomes the measurement start signal M_START.

Next, a test operation of the test apparatus 102 starts (S310). Upon start of a test operation, the period generator 110 generates a reference clock CLK according to the test period. Then a test signal according to the test pattern from the pattern generator 112 is generated by the waveform shaping device 114, the AND gate 118, and the AND gate 120, at a timing that is in accordance with set and reset timing signals from the timing generator 116. The generated test signal is inputted to the terminal of the DUT 100. After a predetermined operation of the DUT 100, an output signal is outputted from the terminal of the DUT 100 as its output.

Next, at a timing designated by the measurement start signal M_START selected by the selection section 130, the measurement circuit 132 starts counting the number of pulses of the output signal of the DUT 100, i.e. the number of pulses of the logical value Dout of the output signal (S320). Following this, the number of pulses is counted till a predetermined time has passed. Alternatively, a time duration until the predetermined number of pulses has been counted is measured (S330).

After this, the control apparatus 108 acquires either the number of pulses until elapse of the predetermined time measured by the measurement circuit 132, or a time duration until the predetermined number of pulses has been measured (S340), and the processing is ended. The measured value acquired by the control apparatus 108 (i.e. the number of pulses until elapse of the predetermined time, or the time duration until the predetermined number of pulses has been counted) is usable for calculation of frequency or calculation of a period of an output signal.

As stated above, according to the test apparatus of the present embodiment, it is possible to count the number of pulses of an output signal in synchronization with a strobe signal STRB designating a timing for acquiring the logical value Dout of an output signal of the DUT 100, or outputting of the logical value Dout itself. As a result, the time required for measuring the frequency of the output signal is shortened. In addition, the accuracy in measurement is enhanced. Furthermore, by controlling a timing for measurement start it becomes easy to start measuring in a particular output signal state, i.e. to locate the beginning of the measurement.

Note that a circuit shown in FIG. 2 is taken as an example of the measurement circuit 132 of the present embodiment. However, it should be noted that it is possible to configure the measurement circuit by arbitrarily combining adequate circuits such as a flip-flop, a counter, and so on, as long as the measurement circuit satisfies the requirement that the measurement of the number of pulses of an output signal, the time during which the number of pulses is measured, and the measurement start are controllable by means of a signal.

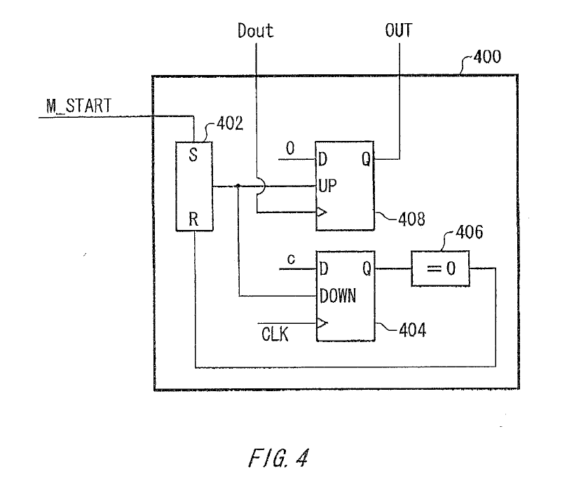

FIG. 4 shows another example of the measurement circuit 132. The measurement circuit 400 includes an SR flip-flop 402, a down counter 404, a logical circuit 206, and an up counter 408. Here, the measurement circuit 400 is designed to count the number of pulses of a logical value Dout of an output signal by means of the up counter 408, instead of counting the number of clocks of the logical value Dout of the output signal by means of the down counter 204 in FIG. 2. The SR flip-flop 402 and the logical circuit 406 may be the same as the SR flip-flop 202 and the logical circuit 206 in FIG. 2.

The down counter 404 is pre-set to a predetermined value “c”, and performs down counting with respect to the number of pulses of the reference clock CLK. The up counter 408 counts the number of pulses of the logical value Dout of the output signal until the output value of the down counter 404 reaches 0. In the measurement circuit 400, it is possible to designate a predetermined time duration by means of the number of reference clocks, and to calculate the frequency of the output signal by using the number of pulses of the logical value Dout measured during the designated predetermined time duration.

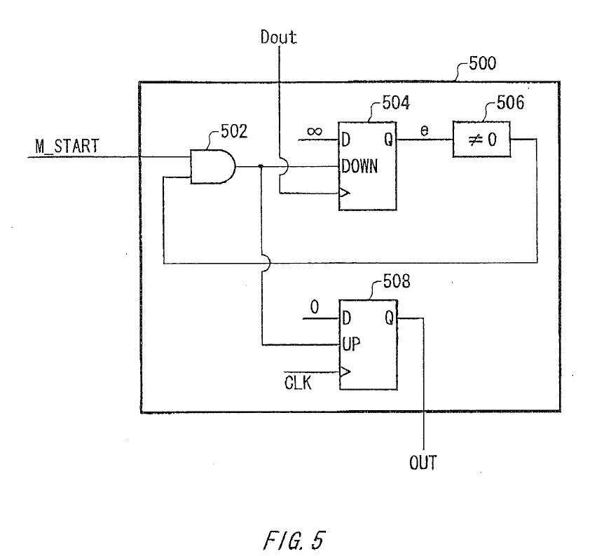

FIG. 5 shows a further different example of the measurement circuit 123. The measurement circuit 500 includes an AND gate 502, a down counter 504, a logical circuit 506, and an up counter 508. The measurement circuit 500 employs the AND gate 502 instead of the flip-flop 202 in FIG. 2. The down counter 504 and the up counter 508 may be the same as the down counter 204 and the up counter 208 in FIG. 2. The output of the logical circuit 506 has a logic reverse to the logic of the output of the logical circuit 206 in FIG. 2. In other words, the output of the logical circuit 506 becomes the logical value “H” when the input is not 0.

The measurement circuit 500 starts an operation of counting each counter by detecting an up edge of a measurement start signal M_START, and ends the counting operation when either the measurement start signal M_START or the output from the logical circuit 506 has reached the logical value “L”. The measurement circuit 500 is also able to end the operation of counters by means of the measurement start signal M_START. As a result, the pre-set value of the down counter 504 is able to be set to an infinite value (practically a sufficiently larger value than the time required for measurement). The number of pulses of the logical value Dout of the output signal can be acquired from the output of the down counter 504, and the time duration during which the counter has been operated can be acquired from the output OUT of the up counter 508.

So far, an aspect of the present invention has been described by way of the embodiments. However the technical scope of the invention is not limited to the above described embodiments. Various alteration or improvements can be added to the above-described embodiments. It is apparent from the scope of the claims that the embodiments to which such alternation or improvements are added can be included in the technical scope of the invention.

For example, the test apparatus 102 may be a test circuit provided in the same electronic device that also incorporates therein a circuit under test to be subjected to testing. The test circuit is realized as a BIST circuit or the like of the electronic device, and conducts diagnosis or the like of the electronic device by testing the circuit under test. As a result, the test circuit is able to check whether a circuit being the circuit under test can perform a normal operation or function in accordance with the original purpose of the electronic device.

In addition, the test apparatus 102 may be a test circuit provided in the same board or in the same apparatus that also incorporates therein a circuit under test to be subjected to testing. Such a test circuit, too, is able to check whether a circuit under test can perform a normal operation or function in accordance with the original purpose.

As clear from the above description, according to one aspect of the present invention, it becomes possible to realize “a test apparatus and an electronic device” capable of shortening a test time in measuring the frequency of an output signal, and having high accuracy in measurement.

What is claimed is:

1. A test apparatus for testing a device under test, the test apparatus comprising:
a pattern generator that generates an expected value pattern of an output signal of the device under test;
a timing generator that generates a timing signal indicating a timing for acquiring the output signal of the device under test by delaying a reference clock;
a comparator that acquires the output signal of the device under test at the timing designated by the timing signal and compares the acquired output signal to the expected value pattern; and
a measurement circuit that starts operating at the timing designated by the timing signal and counts a number of pulses of the output signal of the device under test.

2. The test apparatus as set forth in claim 1, further comprising:
a control apparatus that controls the test apparatus to output a start signal for controlling the test apparatus and instructing measurement start for the measurement circuit; and
a selection section that supplies, to the measurement circuit, a signal selected from among signals including the timing signal and the start signal, wherein
the measurement circuit starts operating at a timing designated by the signal selected by the selection section.

3. The test apparatus as set forth in claim 2, wherein
the selection section supplies, to the measurement circuit, a signal selected from among signals including the timing signal, the output signal of the device under test, and the start signal.

4. The test apparatus as set forth in claim 2, wherein
the comparator outputs a comparison result of comparing the output signal to the expected value pattern, and generates a match signal when the comparison result satisfies a predetermined condition, and
the selection section supplies, to the measurement circuit, a signal selected from among signals including the timing signal, the start signal, and the comparison result or the match signal.

5. An electronic device that includes a test circuit and a circuit under test that is to be tested by the test circuit, wherein the test circuit includes:
a pattern generator that generates an expected value pattern of an output signal of the circuit under test;
a timing generator that generates a timing signal indicating a timing for acquiring the output signal of the circuit under test by delaying a reference clock;
a comparator that acquires the output signal of the circuit under test at the timing designated by the timing signal and compares the acquired output signal to the expected value pattern; and
a measurement circuit that starts operating at the timing designated by the timing signal and counts a number of pulses of the output signal of the circuit under test.
